(19) United States
(12) Patent Application Publication
(10) Pub. No.: US 2009/0214719 A1
(43) Pub. Date: Aug. 27, 2009

(54) Dry State Coating Process

(75) Inventors: Sebastian Gouin, Meyrin (CH); Kathryn Louise Tse, Copenhagen (DK); Carsten Bjørn Hansen, Egaa (DK)

Correspondence Address: DANISCO US INC.;ATTENTION: LEGAL DEPARTMENT, 925 PAGE MILL ROAD, PALO ALTO, CA, 94304, US

(73) Assignee: DANISCO A/S, Copenhagen K (DK)

(21) Appl. No.: 11/988,466

(22) PCT Filed: Jul. 17, 2006
(86) PCT No.: PCT/IB2006/002437

§ 371 Date: May 11, 2009

(30) Foreign Application Priority Data
Jul. 18, 2005 (GB) 0514698.0

(51) Int. Cl. A23L 1/05; B05D 3/00; B05D 1/12; A23L 1/22

(52) U.S. Cl. 426/96; 427/185; 427/193; 428/402.24

(57) ABSTRACT

The present invention relates to a dry state process for coating a substrate, said process comprising the steps of: (A) forming a mixture comprising: (i) particles of a coating material; and (ii) particles of a substrate; wherein the substrate, or at least a portion thereof; and/or the coating material, or at least a portion thereof; is capable of undergoing a glass transition; and (B) sintering the mixture formed in step (A) at a temperature greater or equal to the glass transition temperature of the substrate, or portion thereof, or the coating material, or portion thereof, that is capable of undergoing a glass transition, so as to form a coated substrate.

### FIELD OF THE INVENTION

The present invention relates to a process for encapsulating a substrate.

### BACKGROUND TO THE INVENTION

Film coating is a process of depositing a thin layer of material onto a substrate or core. The process is commonly used to encapsulate solid pharmaceutical forms (e.g. tablets, capsules), food ingredients, agricultural products (e.g. seeds, fruits) and the like.

Film coatings are intended to provide a functional barrier from the surroundings, thereby avoiding adverse effects on the substrate, for example, through atmospheric oxygen, heat, light, moisture, or pH. Providing a functional barrier also allows for the delayed, controlled and/or sustained release of the coated material.

In pharmaceutical forms, film coatings enable the controlled delivery of the active ingredient, for example, coating materials resistant to the acidity of gastric juice can protect the substrate core form from inactivation. Often, these “enteric” coatings also have the property of degrading in basic environments such as the intestinal tract.

In food technology, film coatings typically provide a protective function, for example, by virtue of preventing flavour loss or minimising the penetration of moisture. Additionally, film coatings often improve the aesthetic appearance of the product. Microencapsulation has also been used to mask unpleasant taste in certain ingredients and/or for controlling the release of the encapsulated ingredient at the right place and at the right time. The controlled release of ingredients can improve the effectiveness of food additives, broaden the application range of food ingredients and ensure optimal dosage.

Usually, the process of film coating involves rolling the substrate particles in a pan, or suspending the substrate particles on a cushion of air, and continuously spraying a fine mist of atomized droplets of a coating suspension onto the particles, the droplets coalescing on the surface of the particles to form a film coating. After evaporation of the solvent, a coherent film remains on the surface of the substrate.

There are many encapsulation processes described in the literature, but the majority require the use of solvents in processing, for example, in spray drying, fluid bed coating or interfacial polymerisation.

Coating suspensions based on organic solvents are usually avoided in view of their undesirable toxicity and flammability. Moreover, reclaiming organic solvent fumes given off during spraying from exhaust ducting systems is often expensive, and in some cases a legal requirement. Consequently, water based coating suspensions are generally more desirable, despite often being associated with poor adhesion characteristics. Generally, water based coating compositions are based on aqueous solutions of polymers such as hydrocolloids or cellulose which are sprayed onto the substrate particles.

By way of example, WO 02/19987 (Chr. Hansen, Inc.) discloses a dry powder film coating composition for use in coating pharmaceutical tablets, food and confectionery products which comprises a film forming agent including a powdered cellulosic polymer (such as hydroxypropyl methylcellulose), gum acacia and a powdered edible plasticizer. Gum acacia is used as a low cost alternative to hydroxypropyl methylcellulose. Prior to use, the coating composition. is mixed with water before spraying onto the substrate. The resulting film coating is clear, shiny, durable and extremely economical.

Of the many encapsulation processes described in the literature, the majority require the use of solvents in processing (e.g. spray-drying, fluid bed coating, interfacial polymerisation). A much smaller number of dry coating processes have been described, which use either only a small amount of solvent (e.g. Glatt Powder Coater Granulator process) or no solvent.

Advantageously, dry coating technology is capable of directly attaching different sized particles with a minimum of solvent (or without solvent altogether) and associated waste. The principle is based on the application of mechanical force to a mixture of fine and coarse particles to form an ordered mixture where the coating particles are sufficiently small as to be held to the surface by van de Waals forces. Further mechanical action can cause these particles to generate a continuous coating in the form of a non-porous film or porous layer.

Some dry coating processes use significant mechanical shear either to disperse the coating materials or embed the coating particles into the core material (e.g. Mechanofusion® from Hosokawa, Hybridizer® from Nara Machinery, discussed below) whereas others use magnetic forces to coat the core particles (Magnetically Assisted Impaction Coating, MAIC from Aveka, Inc.). Others use centrifugal forces (e.g. Rotating Fluid Bed Coater, RFBC from New Jersey Institute of Technology). Whilst these methods differ in how the coating and core materials are brought into contact, most result in a coating formed from either an ordered mixture (loose surface coating) or from embedding the coating particles onto the core surface.

As mentioned above, one example of a dry coating process is “Mechanofusion®” (Dry Coating of Powder Materials; Vol 15, No. 2, March/April 2003, p 132-134). This technique generates surface fusion through a combination of high sheer and compression forces acting on particles. The process involves measuring a quantity of core and coating material in powdered form into a chamber. The bowl rotates forcing the powder to circulate and be compressed between the stationary compression head and side walls. Intense forces cause sufficient local heat to fuse the materials together with very strong physical and chemical bonds.

Another dry coating process is described in Honda et al (Chimicaoggi, June 1991, p 21-26; Colloids and Surfaces A: Physicochemical and Engineering Aspects, 82 (1994), 117-128). This method involves a dry impact blending process which utilizes a mechanochemical treatment. The method is capable of changing the randomised arrangement of fine particles on core powder surfaces to an ordered state. Furthermore, polymer or metallic fine particles on core powder surfaces are partially melted by mechanochemical effects; the softened wax-like fine particles are produced on each core powder surface in keeping with increased impact times. The method involves a first step of mechanically blending the core and wall materials to form an interactive mixture. Typically, this is achieved with a centrifugal rotating type batch mixer (for example a Mechanomill MM-10 type, Okadaseiko Co. Ltd, Tokyo). The second step involves mechanical impact blending of the ordered mixture to prepare a composite or encapsulated particles. Typically, an impact type hybridisation machine with jacket is used (for example, a Hybridizer® type-0, Nara Machinery Co. Ltd, Tokyo). In this machine, the powder (ordered mixture) is fed through a chute into the centre of the machine and blown off in a peripheral direction by the centrifugal force generated by the high speed of the rotor. The dispersed powder particles hit the rotating striking pins which rotate at over 10,000 rpm. Consequently, the powder receives the mechanical impact on its surfaces and is blended; powder reaching the periphery reenters the circulation route and returns to the centre of the machine. This cycle is continually repeated.

As mentioned above, some dry coating techniques use magnetic forces to coat the core particles, for example, Magnetically Assisted Impaction Coating, “MAIC”, (Pfeffer et al, Synthesis of Engineered Particulates with Tailored Properties Using Dry Particle Coating; Powder Technology, Vol 117, Issue 1-2, Jun. 4, 2001). This technique is “softer” and uses. an external oscillating magnetic field to accelerate and spin larger magnetic particles mixed in with the core and shell particles promoting collisions between the particles and with the walls of the device. This results in very good mixing and produces mechanical stresses sufficiently large to promote adherent coating of the shell particles onto the surface of the core particles. Advantageously, this technique results in negligible heat generation and minimum changes in material shape and size.

A further dry coating technique known in the art is Rotating Fluidised Bed Coating (RFBC) (Pfeffer et al, ibid). This technique involves placing host and guest powder mixture into a rotating bed and fluidising by a radial flow of gas through the porous wall of the cylindrical distributor. Due to the high rotating speeds, very high centrifugal and shear forces are developed within the fluidised gas-powder system leading to the break up of the agglomerates of the of the guest particles.

The present invention seeks to provide an alternative dry state encapsulation process for coating a substrate. In particular, the invention seeks to provide a dry coating process which does not require significant mechanical, impact, friction or compression forces.

### STATEMENT OF INVENTION

Aspects of the invention are set forth below and in the accompanying claims.

A first aspect of the invention relates to a dry state process for coating a substrate, said process comprising the steps of:

(A) forming a mixture comprising:

(i) particles of a coating material; and

(ii) particles of a substrate;

wherein

the substrate, or at least a portion thereof; and/or

the coating material, or at least a portion thereof;

is capable of undergoing a glass transition; and

(B) sintering the mixture formed in step (A) at a temperature greater or equal to the glass transition temperature of the substrate, or portion thereof, or the coating material, or portion thereof, that is capable of undergoing a glass transition, so as to form a coated substrate.

A second aspect relates to a coated substrate obtainable by the process of the invention.

A third aspect relates to a coated substrate obtained by the process of the invention

A fourth aspect relates to a food product comprising a coated substrate according to the invention.

### DETAILED DESCRIPTION

As mentioned above, a first aspect of the invention relates to a dry state process for coating or encapsulating a substrate, said process comprising the steps set forth above.

Advantageously, and in contrast to prior art dry coating processes, the present invention provides a dry state encapsulation process which proceeds in the absence of any significant mechanical, impact, friction or compression forces. This enables encapsulated materials to be produced more easily and more cost effectively, and avoids the need for specialised apparatus and extended processing times. As the current process occurs in the absence of mechanical forces, it is particularly suitable for use with core materials that need to be treated gently, such as those that are friable or brittle, those that are easily deformable or those that may melt or soften at raised temperatures. The process does not significantly alter the shape or size of the material being encapsulated. In addition, it exploits a characteristic of several food-grade polymeric coating materials which in some instances are known to provide protection against oxidation, light and moisture transfer.

As used herein, the term “dry state” means that the process takes place in the presence of minimal amounts of solvent. Preferably, the process takes place in the absence of solvent altogether.

As used herein, the term “sintering” refers to the process of causing a mixture of particles to become a coherent mass by increasing the adhesion between particles by heating the components to a temperature below the melting point of the components, i.e. by heating without melting.

The dry coating (or dry encapsulation) process takes place between an ordered arrangement of solid “core” material particles (also referred to herein as “substrate particles”) and particles of a solid coating material, the particle size of which is preferably at least one order of magnitude smaller than the core particles. The ordered mixture of coating particles surrounding the core material is then made permanent through exploiting the glass transition of the coating (or core) material, for example, by subjecting to a heating regime that allows the. glass transition of the coating (or core) to be reached.

As the temperature of the mixture exceeds the glass transition temperature of the coating (or substrate) materials, the material transforms from the glassy to the rubbery state. At this point the material becomes sticky and adjacent particles will fuse at the points of contact; for example, this could be coating particles which fuse to one another, as well as to the core, or core particles which fuse to adjacent coating particles.

Preferably, the process of the invention leads to a substrate which is encapsulated by a continuous shell of coating material.

The term “encapsulate” or “encapsulating” is well known in the art. Encapsulation can be defined as the technology of packaging a substrate (solids, liquids, gases) within another material. In the encapsulate, the material which has been entrapped is termed the core material or the internal phase while the encapsulating material is referred to. as the coating or shell material or the carrier. Such encapsulated materials are also commonly referred to as core/shell materials.

In one preferred embodiment of the invention, the mixture is agitated. Advantageously, a degree of agitation prevents the coated particles from adhering to one another as the glass transition is reached.

In one preferred embodiment, the mixture is agitated by stirring. Preferably, the process is carried out in a jacketed mixer, for example, using a Lodïge Type M5, equipped with 5 paddle blades to keep the particles in motion during the process. The coating particles and substrate particles are combined in a closed container to form the ordered mixture before being charged into the barrel of the mixer. The mixture is simultaneously heated to a temperature at or above the glass transition temperature of the coating (or core) materials and agitated to prevent coated particles sticking together. Processing time is of the order of minutes; the particles are discharged and cooled to give the final product.

In another preferred embodiment, the mixture is agitated using a vibration device. For example, the process can be carried out by placing the ordered mixture of coating material and substrate material into a sealed container, which is then attached to a vibration device, such as a Janke & Kunkel VF2 mixer. The whole set-up is then placed into a temperature-controlled environment, such as a convection oven. This set-up allows the mixture to be raised to a temperature at or above the glass transition of the coating (or core) materials, as is required to form a continuous encapsulating layer and also provides sufficient agitation to prevent the coated particles from agglomerating as the glass transition temperature is exceeded.

In another preferred embodiment, the mixture is agitated using a fluid bed, i.e. the mixture is fluidised.

In a gas-solid fluidised system, when the superficial velocity (velocity per unit area) of the fluidising air just exceeds the apparent weight of the solid particles, the particles become freely supported by the fluidising air and the bed is said to be fluidised. The point at which the individual particles separate from one another is known as the minimum fluidisation velocity (u_{mf}) and at this point the bed is said to be incipiently fluidised. If the superficial velocity of the fluidising air increases, the distance between the solid particles also increases until solid particles are transported out of the bed (so-called “pneumatic transport”). In a system where small and large particles have similar particle densities, the small particles will be transported out of the bed first.

Preferably, a suitable operating temperature would be one above the minimum fluidisation velocity of the core material. Most fluid beds can be equipped with a mechanism to recycle fine particles that are transported out of the bed.

More preferably, the system is operated in the range between u_{mf} and the onset of pneumatic transport for the coating particles.

Several variations are possible; for example, in one preferred embodiment, the fluid bed can be charged with the substrate material and coating material.

In an alternative preferred embodiment, the two components can be mixed prior to charging, thus forming an ordered mixture prior to entering the fluid bed.

In another alternative preferred embodiment, a combination of these two approaches is used, where a first coating material is combined with the core material to form an ordered mixture and then a secondary coating material is added into the bed when the contents are under fluidisation. The advantage of this method is that it minimises loss of very fine coating particles through the sieve bottom of the fluid bed (e.g. TiO₂). In one preferred embodiment, the secondary coating material is TiO₂ or SiO₂.

Preferably, heated, humidified air is used as the fluidising gas. Preferably, the processing time is a matter of minutes. After heating, no cooling is required and the finished product can be discharged immediately from the fluid bed.

In one preferred embodiment, the process is carried out in the absence of any substantial mechanical force. For example, in contrast to prior art processes, the presently claimed process is carried out in the absence of significant shear forces that can arise in the space between rapidly moving impeller blades and the vessel wall and which can lead to deformation of core materials. Such mechanical forces are integral to the operation of the Mechanofusion® device as particles are forced between a narrow gap between the rotating vessel wall and a stationary compression head (scraper), where the particles are subjected to intense shearing and compressive forces. These shear and compressive forces generate the heat energy required to “fuse” the coating particles onto the core material.

In another preferred embodiment, the process is carried out in the absence of any substantial impact force. For example, although a preferred embodiment of the process involves using a paddle-blade mixer, the slow blade rotation is used solely to keep the system mixed; it does not contribute to the mechanism by which the coating material becomes fused and the encapsulated particle is formed. This differs significantly from the “impact type hybridization” described in the prior art (Honda, Kimura, Matsuno, Koishi, Preparation of composite and encapsulated powder particles by dry impact blending, ChimicaOggi, June 1991, p 21-26) which is an integral to the function of the Nara Hybridizer® and which is supplied by the six-blade, high-speed rotor.

In another preferred embodiment, the process is carried out in the absence of any substantial friction force. For example, in contrast to prior art processes, the presently claimed process is carried out in the absence of high-impact particle-particle collisions facilitated by high-shear impellers (Nara Hybridizer®) or through particle acceleration through a narrow gap (Mechanofusion®). Although there is some particle-particle contact during the current process, especially in the preferred embodiment using the fluid bed, fluidised beds are considered to have low attrition characteristics (often modeled as frictionless); these contacts are caused by particle suspension on air and are not caused by particle acceleration due to the high-speed impeller action.

In another preferred embodiment, the process is carried out in the absence of any substantial compression force. For example, in contrast to prior art processes, the presently claimed process is carried out in the absence of intense compressive forces such as those used in the above-described Mechanofusion® device to generate the heat energy necessary to fuse the coating to the core particles.

The present dry state encapsulation process can be applied to all materials or mixture of materials that are capable of undergoing a glass transition. It is also possible to use materials that do not exhibit a glass transition for coating, provided they are either used as a mixture combined with materials which do display a glass transition temperature or to coat a substrate material which exhibits a glass transition temperature. Advantageously, using a combination of coating materials allows for the incorporation of additives such as hydrophobic TiO₂ or SiO₂ which can greatly modify the properties of the encapsulation, but which themselves do not undergo a glass transition.

If amorphous (glass transition-exhibiting) coating materials are used, suitable substrate (core) materials for this method are any solid particles (e.g. nutrients, minerals, preservatives). If the coating materials (or mixture or) are not capable of exhibiting a glass transition, then substrate (core) materials are limited to those which can undergo a glass transition, such as hydrocolloids and spray-dried powders (e.g. flavours).

In one preferred embodiment, the coating material, or at least a portion thereof, is capable of undergoing a glass transition. Preferably, for this embodiment, the sintering temperature is sufficient to fuse adjacent particles of the coating material to one another. In an alternative preferred embodiment, the sintering temperature is sufficient to fuse particles of the coating material to the substrate. In an alternative preferred embodiment, the sintering temperature is sufficient to fuse adjacent particles of the coating material to one another, and to the substrate.

In another preferred embodiment of the invention, the substrate, or at least a portion thereof, is capable of undergoing a glass transition. Preferably, for this embodiment, the sintering temperature is sufficient to fuse the substrate to particles of the coating material.

In yet another preferred embodiment of the invention, the coating material, or at least a portion thereof, and the substrate, or at least a portion thereof, is capable of undergoing a glass transition. Preferably, for this embodiment, the sintering temperature is sufficient to fuse the substrate to particles of the coating material, and to fuse adjacent particles of the coating material to one another.

In order for the process to succeed, it is essential that the mixture formed in step (A) can form an ordered mixture in which the coating material particles adhere to the larger substrate particles.

The term “ordered mixture” was first coined by Hersey (1975, Ordered Mixtures—A New Concept in Powder Mixing Practices, Powder Technology, 11 (1), 41-44) to describe self assembling systems observed in mixing cohesive particles and was used to refer to ordered units in which the weight of fine particles adhering to the surface of coarser particles was constant. Ordered mixtures, sometimes also known as interactive mixtures (Egermann, H. & Orr, N. A., 1983, Ordered Mixtures & Interactive Mixtures, Powder Technology, 36 (1), 117), refer to systems consisting of large and small particles, where the small particles spontaneously arrange themselves around the larger and adhere to the surface of the larger particles. The mixture of these cohesive particles is more homogeneous than the random mixture formed by free-flowing particles (Honda, H.; Kimura, M.; Honda, F.; Matsuno, T.; Koishi, M., 1994, Preparation Of Monolayer Particle Coated Powder by the Dry Impact Blending Process Utilizing Mechanochemical Treatment, Colloids and Surfaces: A Physicochemical and Engineering Aspects, 82, 117-128). The adhesion between the fine coating particles and the coarser core material is believed to be driven primarily by van der Waals forces (Youles, J., 2003, Engineered Particles through Mechano Chemical Action, Powder Technology, 15 (2), 132-134).

Ideally, the coating material particles should therefore be significantly smaller in size than the substrate, preferably at least one order of magnitude size difference.

Thus, preferably, the average particle size of the substrate is at least about an order of magnitude greater than the average particle size of the coating material;

In a further preferred embodiment of the invention, the average particle size of the substrate is about one to about two orders of magnitude greater in size than the average particle size of the coating material.

In one preferred embodiment, the average particle size of the substrate is more than about two orders of magnitude greater in size than the average particle size of the coating material.

Usually a significant difference in size in a particle mixture results in segregation, but when the smaller particles are one or two orders of magnitude smaller, an ordered mixture forms, often spontaneously, where the small particles adhere to the larger ones. As mentioned above, an ordered mixture is defined as the bonding of fine particles on one constituent powder to coarser ‘carrier’ particles of a second system (Hersey, 1975, Ordered mixing—a new concept in powder mixing practice, Powder Technology, 11, 41 and differs from that of a random mixture as the particles are arranged due to inter-particle interactions, such as adsorption, chemisorption, electrostatic forces, van der Waals forces or frictional forces (often a combination of forces). As a result of these inter-particle interactions, ordered mixtures are more stable than usual mixtures to segregation (Hersey, 1975, Ordered mixing—a new concept in powder mixing practice, Powder Technology, 11 (1), 41.; Egermann & Orr, 1983, Ordered Mixtures & Interactive Mixtures, Powder Technology, 36 (1), 117.)

In one preferred embodiment, the ratio of substrate to coating material is from about 85 to 95% to about 5 to about 15% by weight.

In one highly preferred embodiment, the ratio of substrate to coating material is about 90% to about 10% by weight.

Ideally, the coating material should have a narrow particle size distribution. Thus, preferably, the coating material has a particle size distribution having a Span value of less than 1.2, where Span is calculated as (D₉₀-D₁₀)/D₅₀.

Ideally, the substrate should have a narrow particle size distribution. This, preferably, the substrate has a particle size distribution having a Span value of less than 1.2, where Span is calculated as (D₉₀-D₁₀)/D₅₀.

As used herein, the term “D₉₀” refers to the particle diameter threshold below which 90% of the particles lie, i.e. 90% of the particles have a diameter of less than the D₉₀-value.

As used herein, the term “D₁₀” refers to the particle diameter threshold below which 10% of the particles lie, i.e. 10% of the particles have a diameter of less than the D₁₀-value.

As used herein, the term “D₅₀” refers to the particle diameter threshold below which 50% of the particles lie, i.e. 50% of the particles have a diameter of less than the D₅₀ -value, and 50% of the particles have a diameter of greater than the D₅₀ value.

In one particularly preferred embodiment, the average particle size (d₃₂) of the substrate is from about 100 to about 1000 μm, more preferably from about 200 to about 900 μm, more preferably still, from about 300 to about 800 μm, even more preferably, from about 300 to about 500 μm Where the substrate is sucrose, preferably, the average particle size is from about 300 to about 500 μm.

In one particularly preferred embodiment, the average particle size (d₃₂) of the coating material is from about 5 to about 150 μm, more preferably from about 50 to about 150 μm, more preferably still from about 100 to about 150 μm. Preferably, where the substrate is sugar, the average particle size of the coating material is from about 100 to about 150 μm.

As mentioned above, the coating material and/or the substrate, or respective portions thereof, must be capable of undergoing a glass transition.

As used herein, the term “glass transition” refers to a reversible change that occurs in an amorphous solid when it is heated to a certain temperature range.

An amorphous solid is a solid in which there is no long range order of the positions of the atoms. Amorphous solids can exist in two distinct states, the “rubbery” state and the “glassy” state. The temperature at which they transition between the glassy and rubbery states is called their glass transition temperature or Tg. Glass transition is characterized by a rather sudden transition from a hard, glassy or brittle condition to a flexible or elastomeric condition. The transition occurs when the polymer molecule chains of the solid, normally coiled, tangled and motionless at temperatures below the glass transition range, become free to rotate and slip past each other. The glass transition temperature varies widely among polymers, and the range is relatively small for most polymers. Glass transition is also known as “gamma transition” or “second order transition”.

In one preferred embodiment, the coating material, or at least a portion thereof, is capable of undergoing a glass transition. Preferably, for this embodiment, the substrate can be any substrate, for example, any solid particle. Suitable substrates include, for example, a food substrate, food additive, a nutrient, a mineral, a preservative, moldings, pharmaceutical products such as tablets or capsules, crystals, and agricultural products such as plant seeds or fruit.

Preferably, the substrate is a food substrate. More preferably, the substrate is selected from crystalline sugar, xylitol and, hydrocolloid (e.g. pectin, carrageenan, alginate). In one highly preferred embodiment, the substrate is decorating sugar, for example, Pearl Maxi (Danisco, 300-500 μm).

In one preferred embodiment, the substrate is a food substrate or a food additive.

Where the coating material, or at least a portion thereof, is capable of undergoing a glass transition, preferably the coating material comprises a polymeric coating material.

In one particularly preferred embodiment, the coating material comprises a cellulose polymer, or derivative thereof. More preferably, the cellulose polymer, or derivative thereof, is selected from hydroxypropylmethylcellulose (HPMC), hydroxypropylcellulose (HPC), methylcellulose (MC) and sodium carboxymethylcellulose (NaCMC).

Other suitable polymers include food-grade polymers such as gums (arabic, karaya, tragacanth, tara, guar, ghatti, gellan, xanthan), and polysaccharides (agar-agar, locust-bean gum, konjac, alginate, carrageenan, pectin, pullulan, curdlan.

In another preferred embodiment, the coating material comprises a dextrin, a gelatinised starch, a modified starch, hydrolysed starch, polydextrose (for example, Litesse®), a monosaccharide or a disaccharide, at least a portion of which is in amorphous form.

In one preferred embodiment, the coating material is all, or substantially all, in amorphous form.

In one preferred embodiment, the coating material is a mixture of two or more materials. For example, the coating material may comprise one or more of the above-described materials in combination with one or more additional components, such as one or more hydrophobic agents.

Other suitable additional components include, for example, one or more pigments.

In one highly preferred embodiment, the coating material comprises TiO₂ and/or SiO₂.

In one especially preferred embodiment, the substrate is sugar and the coating material comprises sodium carboxymethylcellulose (NaCMC).

In another especially preferred embodiment, the substrate is sugar, and the coating material comprises hydroxypropylmethylcellulose (HMPC).

In another especially preferred embodiment, the substrate is sugar, and the coating material comprises a mixture of sodium carboxymethylcellulose/TiO₂. Preferably, the ratio of sodium carboxymethylcellulose : TiO₂ is about 95:5 to 80:20, more preferably, about 90:10.

In yet another preferred embodiment, the substrate is sugar, and the coating material comprises a mixture of sodium carboxymethylellulose/SiO₂. Preferably, the ratio of sodium carboxymethylcellulose : SiO₂ is about 95:5 to 80:20, more preferably, about 90:10.

Preferably, where the coating material comprises HMPC, NaCMC or mixtures containing HMPC and NaCMC, step (B) involves sintering the mixture at a temperature of at least 80° C. (i.e. the temperature at which minimum effect is observed). More preferably, step (B) involves sintering the mixture at a temperature of at least about 100° C. Even more preferably, step (B) involves sintering the mixture at a temperature of at least about 120° C.

In one highly preferred embodiment, the mixture is sintered at a temperature of about 120° C.

As discussed above, one aim of the present invention is to provide a substrate in a form protected from degradation or inactivation. However, the substrate should of course be released when required.

Preferably, the coating is capable of protecting the substrate from one or more of oxidation, moisture uptake and degradation by light.

In one embodiment of the present invention the coating is selected to prevent, reduce or inhibit degeneration or inactivation of the substrate. Preferably the degeneration which is to be prevented is by one or more factors selected from heat degradation, pH induced degradation, protease degradation and glutathione adduct formation.

Another aspect of the invention relates to a coated substrate obtainable by the process of the invention.

A further aspect of the invention relates to a coated substrate prepared by the process of the invention.

Another aspect of the invention relates to a food product comprising a coated substrate according to the invention.

Preferably, the food product is a bakery, fine bakery, dairy, meat, or confectionery product

The present invention is further illustrated by way of example and with reference to the following figures wherein:

FIG. 1 shows a schematic representation of the dry coating process of the invention.

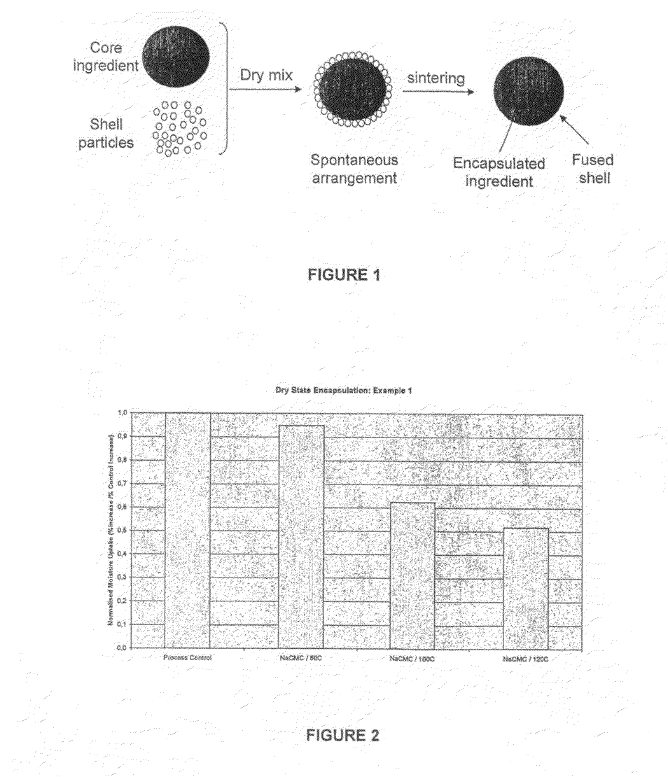

FIG. 2 shows normalised moisture uptake (% increase/% control increase) for the process control; and sugar coated with NaCMC sintered at 80° C., 100° C. and 120°0 C. respectively.

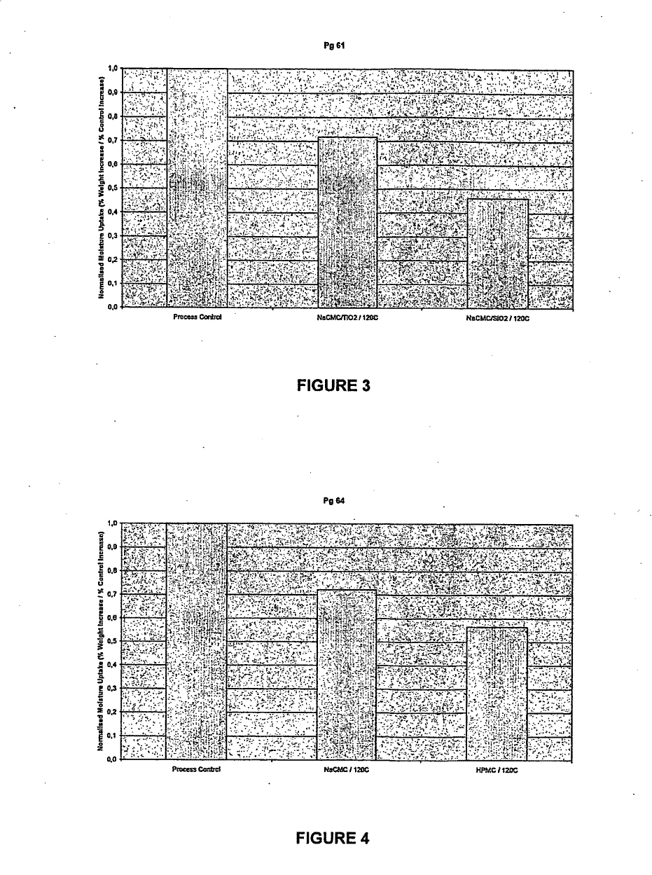

FIG. 3 shows normalised moisture uptake (% increase/% control increase) for the process control; sugar coated with a 3:1 NaCMC:TiO₂ mixture sintered at 120° C.; and sugar coated with a 3:1 NaCMC:SiO₂ mixture sintered at 120° C.

FIG. 4 shows normalised moisture uptake (% increase/% control increase) for the process control; sugar coated with NaCMC sintered at 120° C.; and sugar coated with HPMC sintered at 120° C.

### EXAMPLES

All of the samples are benchmarked against a ‘Process Control’, which is a sample of uncoated sucrose that has been treated under the same conditions as the encapsulated samples.

### Coating of Decoration Sugar for Increased Moisture Resistance

### Example 1

Core material: Decorating sugar (Pearl Maxi, Danisco, 300-500 μm)

Coating material(s): Sodium carboxymethylcellulose (NaCMC) [High Viscosity grade, ex CalBioChem]

The coating material chosen was high viscosity NaCMC, with average particle size (d₃₂) of 77 μm. Differential scanning calorimetry (DSC) testing (heating range 25-200° C.; heating rate 20° C. min⁻¹; T_{g} measured at midpoint) was used to measure the T_{g} and gave a value of 60° C. The use of DSC to measure T_{g} will be familiar to the skilled person and can be measured using any suitable DSC apparatus (for example, Perkin Elmer DSC apparatus, or Setarim DSC France). Further details on the technique may be found in Hatley, R. H. (Dev Biol Stand. 1992;74:105-19; discussion 119-22). Literature T_{g} values may be found in Roos, Y. and Karel, M. (Differential Scanning Calorimetry Study of Phase Transitions Affecting the Quality of Dehydrated Materials, Biotechnology Progress, 6(2): 159-163, 1990).

120 g of the coating material (10% more than required to meet a 10:90 coating:core ratio, to allow for possible losses through pneumatic transport) and lkg of the core material was added into the product chamber of an Aeromatic-Fielder AG, Model EX fluid bed. The mixture was fluidised at a low airflow of 40 m³/hr in order to prevent the fine coating particles from being pneumatically transported out of the bed. For all trials, the fluidising air was humidified to lower the temperature required to reach the glass transition of the coating material. In three trials, the fluidising air temperature was set to 80° C., 100° C. or 120° C., respectively. rluidisation was continued for 6 minutes, after which the fluidising air-flow was stopped and the product chamber emptied.

The product was tested in a humidity chamber, maintained at 80% relative humidity (RH). Samples of 2 g were placed onto a glass Petri dish, weighed and then exposed for 24 hours, after which time they were removed and reweighed. All testing was carried out in duplicate. Trials were carried out using a process control to benchmark results.

As shown in FIG. 2, almost a 50% reduction in moisture uptake, compared to that of the process control, can be achieved, using a processing temperature of 120° C.

### Example 2

Core material: Decorating sugar (Pearl Maxi, Danisco, 300-500 μm)

Coating material(s): 90 g NaCMC

10 g TiO₂ [AFDC-300, ex Kemira] or 10 g SiO₂ [Sipemate S22 ex Degussa]

The NaCMC used in the trial was the same grade as in Example 1. The average particle size (d₃₂) of the SiO₂ was 7 μm. The average particle size (d₃₂) of the TiO₂ was 270 nm. The coating material was a blend of 9:1 polymer: SiO₂, to ensure a continuous coating could be formed around the core material.

The coating material was mixed together in a closed container, prior to the addition of the core material. After the addition of the core material, the ordered mixture was added to the product chamber of an Aeromatic-Fielder AG, Model EX fluid bed. The mixture was fluidised at a low airflow of 40 m³/hr, using humidified inlet air and the temperature maintained at 120° C. for 6 minutes, before the product chamber was emptied.

Samples were tested in the humidity chamber as per Example 1. The results are shown in FIG. 3.

### Example 3

Core material: Decorating sugar (Pearl Maxi, Danisco, 300-500 μm)

Coating material(s): 90 g NaCMC

10 g TiO₂ [AFDC-300, ex Kemira]

The average particle size (d₃₂) of the TiO₂ was 270 nm. The coating material was a blend of 9:1 polymer : TiO₂, to ensure a continuous coating could be formed around the core material. An ordered mixture was formed by mixing the NaCMC and core material together in a closed container. The mixture was then discharged into the product container of an Aeromatic-Fielder AG, Model EX fluid bed. The secondary coating material (TiO₂) was added to the fluid bed through a flexible pipe entering the fluid bed just below the product chamber. The secondary coating material was carried through the sieve bottom into the product chamber on the fluidising air, where it was combined with the ordered mixture. Following the addition of the secondary coating material, the temperature of the (humidified) fluidising air was set to 120° C. and the bed contents were fluidised for 6 minutes. After this time, fluidising ceased and the product chamber was emptied.

Samples were tested in the humidity chamber as per Example 1.

### Example 4

Core material: Decorating sugar (Pearl Maxi, Danisco, 300-500 μm)

Coating material(s): 120 g HPMC [Methocel E4M ex Dow Corning]

The coating material chosen was HPMC, with average particle size (d₃₂) of 77 μm. DSC testing (heating range 25-250° C.; heating rate 20° C. min⁻¹; T_{g} measured at midpoint) was used to measure the T_{g} and gave a value of 108° C.

An ordered mixture was formed by mixing the HPMC and core material together in a closed container. The mixture was then discharged into the product container of an Aeromatic-Fielder AG, Model EX fluid bed. Following the addition of the secondary coating material, the temperature of the (humidified) fluidising air was set to 120° C. and the bed contents were fluidised for 6 minutes. After this time, fluidising ceased and the product chamber was emptied.

Samples were tested in the humidity chamber as per Example 1. The results are shown in FIG. 4.

By way of summary, the present invention provides a dry state encapsulation process, which proceeds in the absence of significant mechanical, impact, friction or compression forces.

The encapsulation process takes place between an ordered arrangement of solid core material particles and particles of a solid coating material, the particle size of which is. at least one order of magnitude smaller than the core. The ordered mixture of coating particles surrounding the core material is made permanent through exploiting the glass transition of the coating (or core) material, for example, by subjecting to a heating regime that allows the glass transition of one or other materials to be reached.

Various modifications and variations of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in the relevant fields are intended to be covered by the present invention.

1. A dry state process for coating a substrate, said process comprising the steps of:
(A) forming a mixture comprising:
(i) particles of a coating material; and
(ii) particles of a substrate;
wherein
the substrate, or at least a portion thereof; and/or
the coating material, or at least a portion thereof;
is capable of undergoing a glass transition; and
(B) sintering the mixture formed in step (A) at a temperature greater or equal to the glass transition temperature of the substrate, or portion thereof, or the coating material, or portion thereof, that is capable of undergoing a glass transition, so as to form a coated substrate.

2. A process according to claim 1 wherein the mixture is agitated.

3. A process according to claim 2 wherein the mixture is agitated by stirring.

4. A process according to claim 2 wherein the mixture is agitated using a vibration device.

5. A process according to claim 2 wherein the mixture is agitated using a fluid bed.

6. A process according to any preceding claim wherein the mixture is fluidised.

7. A process according to any preceding claim which is carried out in the absence of mechanical, impact, friction or compression forces.

8. A process according to any preceding claim wherein the coating material, or at least a portion thereof, is capable of undergoing a glass transition.

9. A process according to claim 8 wherein the sintering temperature is sufficient to fuse adjacent particles of the coating material to one another.

10. A process according to claim 8 wherein the sintering temperature is sufficient to fuse particles of the coating material to the substrate.

11. A process according to claim 8 wherein the sintering temperature is sufficient to fuse adjacent particles of the coating material to one another, and to the substrate.

12. A process according to any preceding claim wherein the substrate, or at least a portion thereof, is capable of undergoing a glass transition.

13. A process according to claim 12 wherein the sintering temperature is sufficient to fuse the substrate to particles of the coating material.

14. A process according to any preceding claim wherein the coating material, or at least a portion thereof, and the substrate, or at least a portion thereof, are capable of undergoing a glass transition.

15. A process according to claim 14 wherein the sintering temperature is sufficient to fuse the substrate to particles of the coating material, and to fuse adjacent particles of the coating material to one another.

16. A process according to any preceding claim wherein the average particle size of the substrate is at least an order of magnitude greater than the average particle size of the coating material.

17. A process according to any preceding claim wherein the average particle size of the substrate is one to two orders of magnitude greater in size than the average particle size of the coating material.

18. A process according to any preceding claim wherein the average particle size of the substrate is more than two orders of magnitude greater in size than the average particle size of the coating material.

19. A method according to any preceding claim wherein the ratio of substrate to coating material is from about 85 to 95% to about 5 to about 15%.

20. A process according to any preceding claim wherein the ratio of substrate to coating material is about 90% to about 10%.

21. A process according to any preceding claim wherein the coating material has a particle size distribution having a Span value of less than about 1.2, where Span is calculated as (D₉₀-D₁₀)/D₅₀.

22. A process according to any preceding claim wherein the substrate has a particle size distribution having a Span value of less than about 1.2, where Span is calculated as (D₉₀-D₁₀)/D₅₀.

23. A process according to any preceding claim wherein the coating material comprises a polymeric coating material.

24. A process according to any preceding claim wherein the coating material comprises a cellulose polymer, or derivative thereof.

25. A process according to any preceding claim wherein cellulose polymer, or derivative thereof, is selected from hydroxypropylmethylcellulose (HPMC), hydroxypropylcellulose (HPC), methylcellulose (MC) and sodium carboxymethylcellulose (NaCMC).

26. A process according to any one of claims 1 to 22 wherein the coating material comprises a dextrin, a gelatinised starch, a modified starch, a monsaccharide or a disaccharide, at least a portion of which is in amorphous form.

27. A process according to claim 26 wherein the coating material is in amorphous form.

28. A process according to any preceding claim wherein the coating material flier comprises a hydrophobic agent.

29. A process according to claim 28 wherein the coating material further comprises a hydrophobic agent selected from TiO₂ and SiO₂.

30. A process according to any preceding claim wherein the coating material, or at least a portion thereof, is capable of undergoing a glass transition, and the substrate is any solid particle.

31. A process according to claim 30 wherein the substrate is selected from a food substrate, food additive, a nutrient, a mineral and a preservative.

32. A process according to claim 31 wherein the substrate is a food substrate.

33. A process according to claim 31 wherein the substrate is selected from crystalline sugar, xylitol and a hydrocolloid.

34. A process according claim 31 wherein the substrate is sugar, and the coating material comprises sodium carboxymethylcellulose.

35. A process according to claim 31 wherein the substrate is sugar, and the coating material comprises hydroxypropylmethylcelluiose (HMPC).

36. A process according to claim 31 wherein the substrate is sugar, and the coating material comprises a mixture of sodium carboxymethylcellulose/TiO₂.

37. A process according to claim 36 wherein the ratio of sodium carboxymethylcellulose:TiO₂ is about 3:1.

38. A process according to claim 31 wherein the substrate is sugar, and the coating material comprises a mixture of sodium carboxymethylcellulose/SiO₂.

39. A process according to claim 38 wherein the ratio of sodium carboxymethylcellulose:SiO₂ is about 3:1.

40. A process according to any one of claims 31 to 39 wherein step (B) involves sintering the mixture at a temperature of at least 80° C.

41. A process according to any one of claims 31 to 40 wherein step (B) involves sintering the mixture at a temperature of at least 100° C.

42. A process according to any one of claims 31 to 41 wherein step (B) involves sintering the mixture at a temperature of at least 120° C.

43. A process according to any preceding claim wherein the average particle size (d₃₂) of the substrate is from about 100 to about 1000 μm.

44. A process according to any preceding claim wherein, the average particle size (d₃₂) of the substrate is from about 300 to about 500 μm.

45. A process according to any preceding claim wherein the average particle. size (d₃₂) of the coating material is from about 5 to about 150 μm.

46. A process according to any preceding claim wherein the average particle size (d₃₂) of the coating material is from about 100 to about 150 μm.

47. A coated substrate obtainable by the process of any one of claims 1 to 46.

48. A coated substrate prepared by the process of any one of claims 1 to 46.

49. A food product comprising a coated substrate according to claim 47 or claim 48.

50. A food product according to claim 49 which is a bakery, fine bakery, dairy, meat or confectionery product

51. A dry state process for coating a substrate substantially as described herein, with reference to any one of the accompanying Examples.

52. A coated substrate substantially as described herein, with reference to any one of the accompanying Examples.
